(19) United States
(12) Patent Application Publication
(10) Pub. No.: US 2010/0307315 A1
(43) Pub. Date: Dec. 9, 2010

(54) Instrument Attached Cappers

(76) Inventor: Ronald F. Swanson, Barrington, IL (US)

Correspondence Address: Ronald F. Swanson, 756 S. Summit, Barrington, IL, 60010, US

(21) Appl. No.: 12/794,122

(22) Filed: Jun. 4, 2010

Related U.S. Application Data
(60) Provisional application No. 61/217,754, filed on Jun. 4, 2009.

(51) Int. Cl. G10D 3/14

(52) U.S. Cl. 84/304

(57) ABSTRACT

The invention provides an instrument or instrument-like device with an attachment capper to personalize and enhance the aesthetic value of a musical experience. Thus the invention provides an instrument attachment capper adapted to connect to an instrument or instrument-like device. The instrument attachment capper has a body that defines a pair of spaced apart faces, one of the faces adapted to be secured to the instrument or instrument-like device, and another of the faces adapted for protective, educational, or decorative purpose(s). The body includes a cup, which may also contain a slit. The invention also provides an instrument attachment capper that is characterized as an acoustic guitar bridge pin. The invention further provides an instrument attachment capper that can be affixed to the instrument with a hook or hangar.

### CROSS-REFERENCE TO RELATED APPLICATION

This patent application claims the benefit of U.S. Provisional Patent Application No. 61/217,754, filed Jun. 4, 2010.

### TECHNICAL FIELD

This invention relates to an attachment capper for instruments or instrument-like devices. More particularly, it is directed to an attachment capper primarily to attach decorative or protective components in a variety of musical connection arrangements.

### BACKGROUND OF THE INVENTION

In many musical situations, performers wish to enhance their experience in a multitude of esthetic and functional manners. Important functional concerns include, for example, safety from cuts from strings and cleanliness from dirt and grime, which may otherwise negatively impact from the experience for the musician and/or any audience members. Moreover, the experience can also be enhanced through creative or decorative additions to the instruments that allow specific customization, individual expression and/or use of particular memorabilia.

Accordingly, there exists an unmet need for musicians and music aficionados for new and interesting ways to customize their instruments and instrument-like devices, whether for decorative or functional reasons.

### BRIEF SUMMARY OF THE INVENTION

In view of the foregoing, it is an object of the invention to provide an instrument or instrument-like device with an attachment capper to personalize and enhance the aesthetic value of a musical experience.

It is a related object of the invention to provide the ability to protect a musician and/or an instrument or instrument-like device against any injury related to certain sharp objects or parts of the instrument, such as cut strings and the like. Also, it is an object of the invention to maintain the cleanliness and/or musical effectiveness of an instrument by covering certain sensitive tuning components and protecting the same against wear and/or undesired maladjustments.

These objects are achieved by the present invention, which provides an instrument attachment capper adapted to connect to an instrument or instrument-like device. The instrument attachment capper has a body that defines a pair of spaced apart faces, one of the faces adapted to be secured to the instrument or instrument-like device, and another of the faces adapted for protective, educational, or decorative purposes. The body includes a cup, which may also contain a slit for certain advantageous uses.

The invention also provides an instrument attachment capper adapted to connect to an instrument or instrument-like device, with a body defining a pair of spaced apart faces that is characterized as an acoustic guitar bridge pin.

The invention further provides an instrument attachment capper adapted to connect to an instrument or instrument-like device, where the instrument attachment capper has a body that can be affixed to the instrument with a hook or hangar, with another of the body faces adapted for protective, educational, or decorative purpose(s).

Additional objects, embodiments and details of this invention can be obtained from the following detailed description of the invention.

### BRIEF DESCRIPTION OF THE SEVERAL VIEWS OF THE DRAWING(S)

FIG. 1 shows a button capper of one embodiment of the invention from a plan view perspective.

FIG. 2 shows the button capper from a front view perspective.

FIG. 3 shows the button capper from a sectional perspective through slice A as indicated on FIG. 1.

FIG. 4 shows the button capper from a bottom view perspective.

FIG. 5 shows another embodiment of the invention, wherein the guitar-tuning peg (or post) turns and moves a guitar string when pulled taut back towards the guitar.

FIG. 6 shows a capper of another embodiment of the invention from a side view, wherein an additional slot allows a guitar string past in a horizontal direction as well as a vertical direction.

FIG. 7 shows a capper of yet another embodiment of the invention being snapped onto a guitar like a button, wherein the capper does not touch the strings.

FIG. 8 shows a capper of an embodiment of the invention attached to a guitar head from a side view and shows another capper ready to be attached from a bottom view showing its string slot.

FIG. 9 shows a capper attached to a guitar from the front view perspective.

FIGS. 10 and 11 show a capper and a capper post from various perspectives to illustrate how a slot in a cup of the capper can fit over a string on the guitar.

FIG. 12 shows various decorative cappers designs.

FIG. 13 shows a side view sectional perspective of still another embodiment of the invention as attached to a tuning post with an external groove provided on a cup of the capper.

FIG. 14 shows a side view sectional perspective of an embodiment of the invention as alternatively attached to parallel strings of a guitar using external grooves in the capper cup.

FIG. 15 shows an underside of an embodiment from a bottom view perspective.

FIG. 16 shows a classical guitar embodiment containing a capper with external cup grooves inserted between strings.

FIG. 17 shows an instrument-like guitar game controller and a jacket or sleeve adaptor embodiment with simulated tuning posts designed to fit various cappers.

FIG. 18 illustrates using an adaptor to fit a capper to the head of a game controller in sequential steps.

### DETAILED DESCRIPTION OF THE INVENTION

In preferred embodiments, the present invention attaches to an instrument-like device that can be an actual instrument or that can be a simulated instrument such as a toy or computer game controller. The instrument-like devices preferably represent stringed instruments with pegs or posts that can be plucked or hammered or otherwise manipulated to play music, such that the attachment can be added to increase the esthetic or functional value of the experience. In some embodiments the attached device may be referred to as a “tuneroo” or a capper, and such labels are hereby meant to be defined as interchangeable in illustrating various aspects of the invention. Moreover, specific references may be made to guitar instruments below, but such references are not meant to limit the invention to that particular instrument. The invention is meant to broadly encompass many types of instruments, or simulations of instruments, including without limitation dulcimers, cellos, violins, violas, basses, banjos, mandolins, and other conventionally understood stringed instruments. Simulations of instruments include, for example, the popular controllers for certain game systems, such as for the games Guitar Hero, Rock Band, or any other game that utilizes a guitar shaped controller, being that they are simulations of guitars then they would also be included in certain intended purposes of the tuneroo.

In one embodiment of the present invention, a guitar peg capper is a cylinder shaped piece of plastic or rubber with a small slit along one side, which fits neatly over the tuning peg portion of the guitar tuning mechanism located on the headstock portion of the guitar. The small slit allows the capper to fit past the part of the string that is taut toward the nut. A functional purpose of the capper being to prevent a finger from being pricked on an end of a cut string by covering the cut end by cupping over the entire (or at least part of) the tuning peg. The slit thus would allow for the portion of string that is taut (which is connected past the nut over the frets and to the bridge on the other side of the guitar) to pass through without material effect on the act of tuning the instrument.

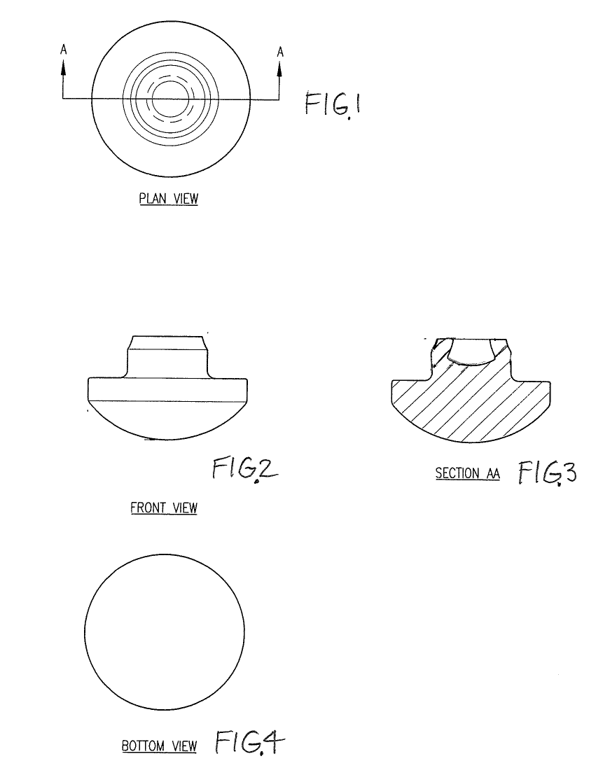

FIGS. 1-4 illustrate an embodiment of the invention from different views, including a plan view, a front view, a sectional view, and a bottom view. In this embodiment, a mushroom like capper is illustrated without a slit. The bottom view, FIG. 4, shows a circular decorative surface. The sectional view, FIG. 3, shows a gap in the cup of the capper that is used to fit over a guitar peg or post.

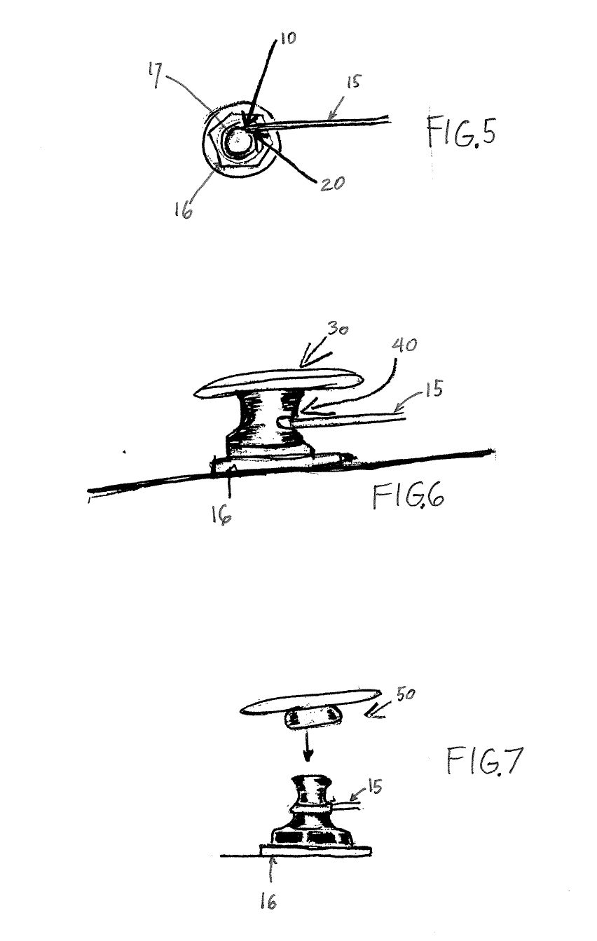

FIG. 5 illustrates another embodiment of the invention, from a top view perspective, that further contains both horizontal and vertical slits. One slit is used to insert the capper 17 over the guitar peg or post 16, while the other slit 40 (as shown for a different shaped capper 30 in FIG. 6) allows the string 15 to rotate upon tightening. Directions 10 and 20 indicate how the string 15 is pulled taut and backwards upon a post 16.

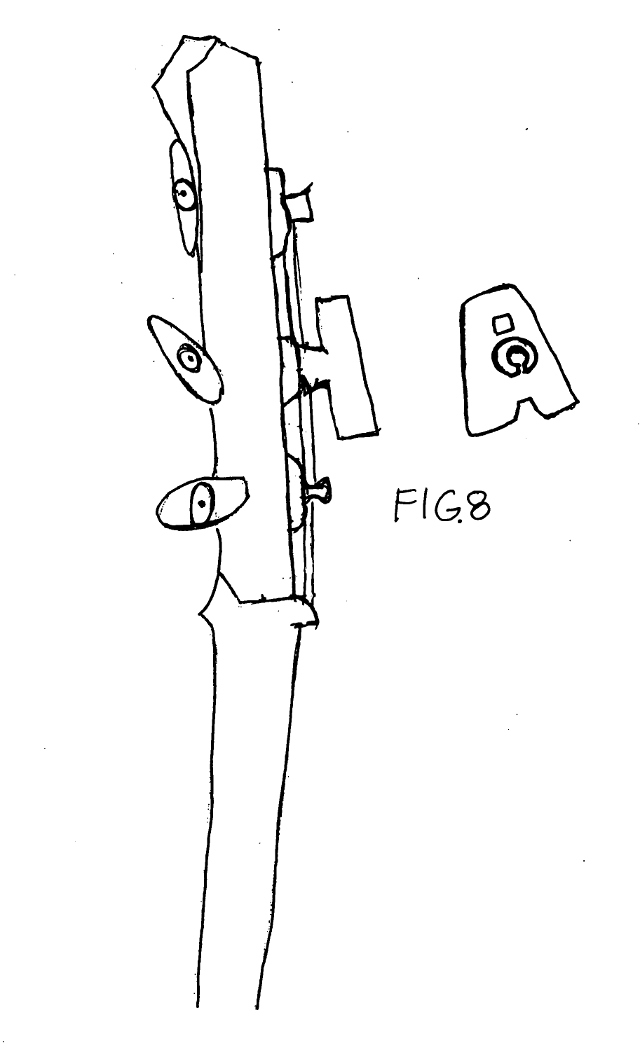

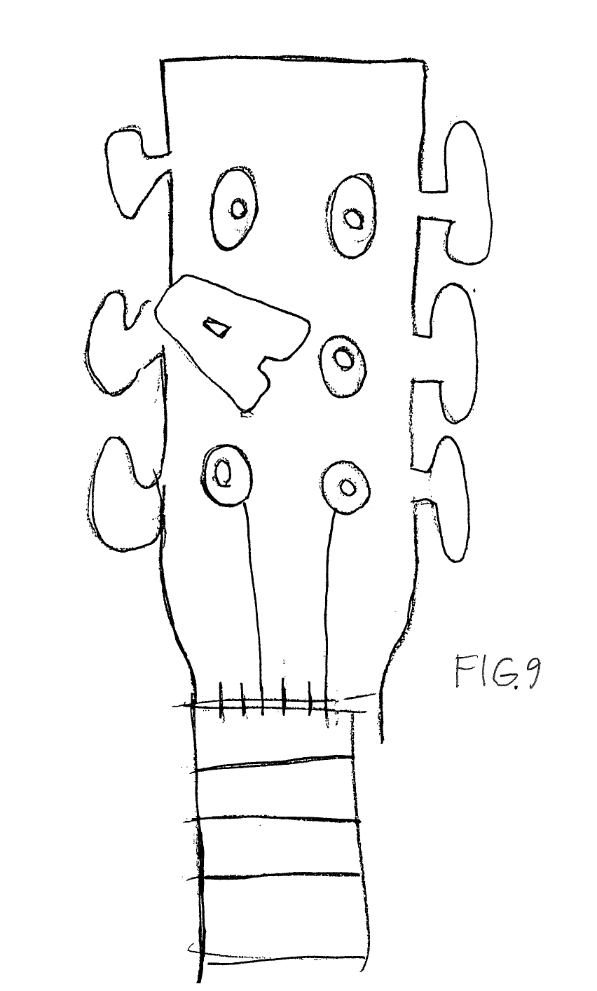

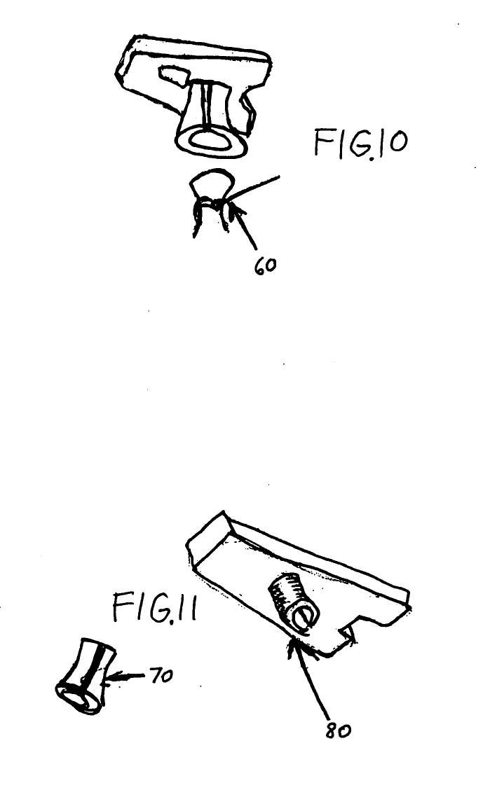

In another embodiment of the invention, the capper is snapped onto an instrument tuning peg, and the capper fits by snapping such as a button (for example, like a raincoat button or a piece of luggage), or if made with rubber to tightly fit over the part of the tuning post up until where the string is wrapped around the post, or where the hole in the post is located for the string to tie through. Although this design embodiment does not completely cover the sharp end of the string completely, it blocks it from being accessible for accidental touching. This type of embodiment is illustrated in FIGS. 1-4, and also in FIG. 7, which shows a flatter capper 50 being snapped another post 16, and the capper 50 does not directly touch string 15.

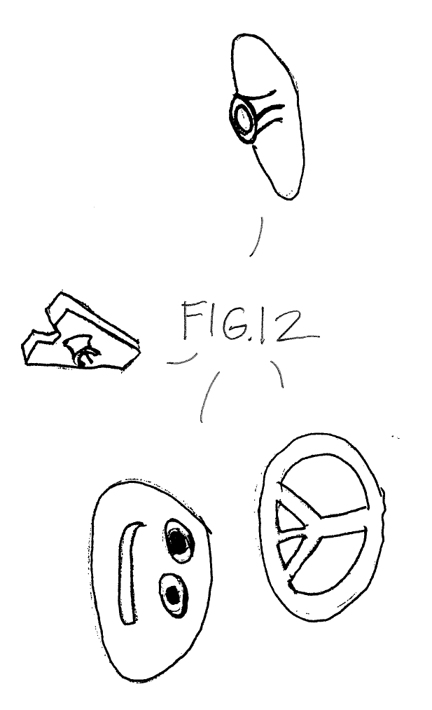

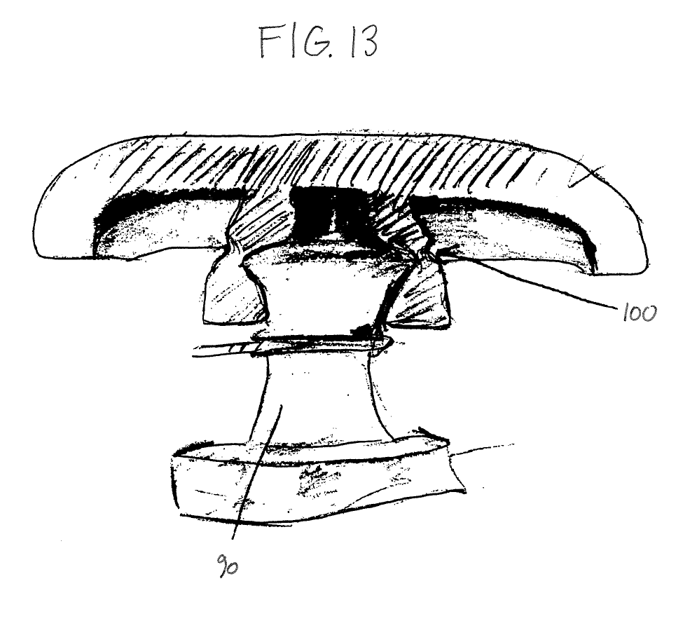

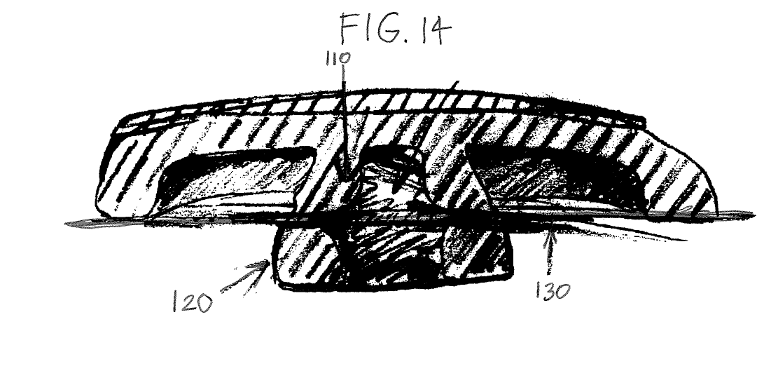

In yet another embodiment of the invention, the main purpose of the product is decorative and uses a guitar peg capper to attach decorations to the tuning pegs of a guitar. An exemplary illustration of a decoration is a three-dimensional “letter A” as shown in FIGS. 8-12. On the backside of this letter 80 is a slit cylindrical cap 70 that would extend to cup and enclose over the tuning peg 60 of a guitar, and thus hold the decorative piece in place on the instrument for all to see. Other exemplary decorations include, without limitation, various colors or color combination designs, and such designs can include various well-known graphic images ranging from a peace sign to a smiley face, or the images can include band logos, company logos, collegiate seals, national flags, or even holiday designs, and educational designs to help students learn the instrument. See, for example, FIG. 12. Educational pieces such as rubber numbers or letter names that can helpfully remind young students of string names by note, or also by string number, would all be included under the category of being a tuneroo. A tuneroo can also be a promotional product which would serve as the vehicle for carrying the images or logos, designs or cultural icons, public domain or not (i.e. in the same manner as a t-shirt, baseball cap, keychain, pencil, soda can cozy, and so on).

In addition to the two dimensional designs, are three-dimensional designs which attach to the guitar in any manner resembling the manner in which the tuneroos are attached. Exemplary materials include solid material such as “FLEXOBRITE™” or colored or otherwise rubber or PVC type materials that would be miniature or full sized “blow up” tuneroos, similar to a beach ball or other novelty balloons made to be inflated or blown up. One example would be a beach ball with a small button on it that attaches to the tuning post of a guitar or bass, which would be considered within the scope of certain tuneroos.

In addition to items that could attach to the head of a guitar for decorative or otherwise purposes on just one of the tuning posts, would be tuneroos that could attach to the guitar in the same manner except with more than one attachment piece. One example of this would be a tuneroo which would completely obstruct the view of the entire headstock, and attach by means of all six tuning posts as one “LEGO®” block would attach to another. Because guitars are very customized and can have any number even or odd of tuning posts, tuneroos of any shape with any number of buttons to attach to the tuning posts would also be included within this embodiment.

Because not all guitars have their tuning pegs on the headstock, but rather behind the bridge of the guitar it must be stated clearly that the act of placing a decoration in a similar manner on a tuning post of any kind whether it be on the end of the neck, or behind the bridge or anywhere else on the guitar would also be encompassed as an embodiment of the present invention.

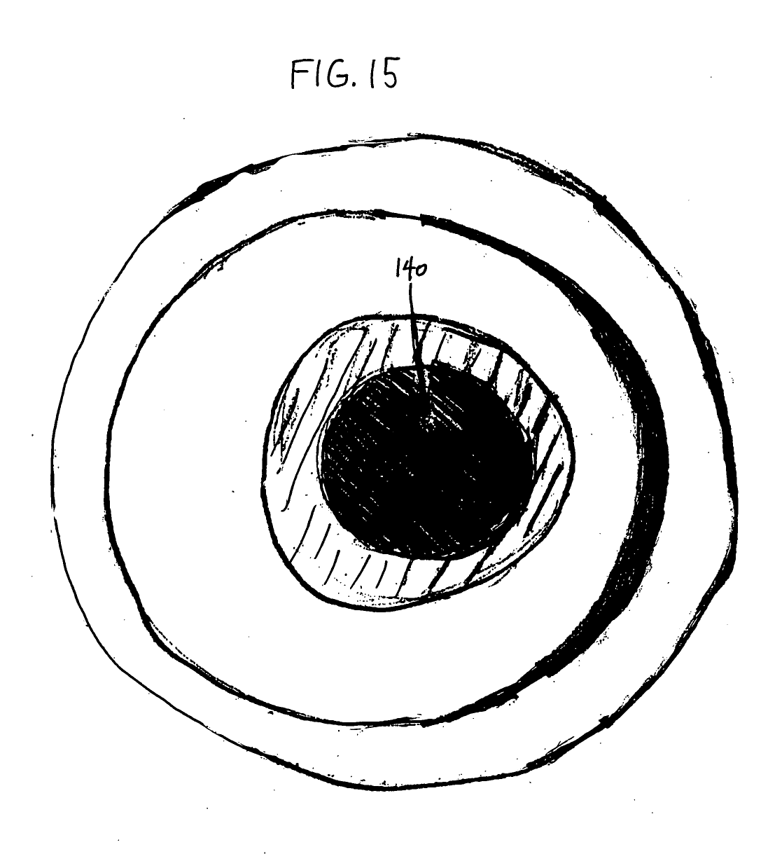

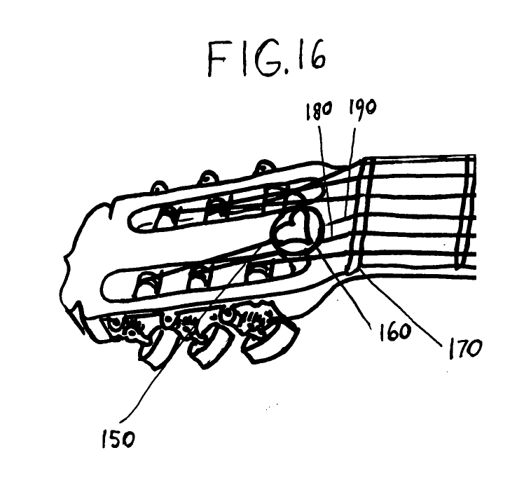

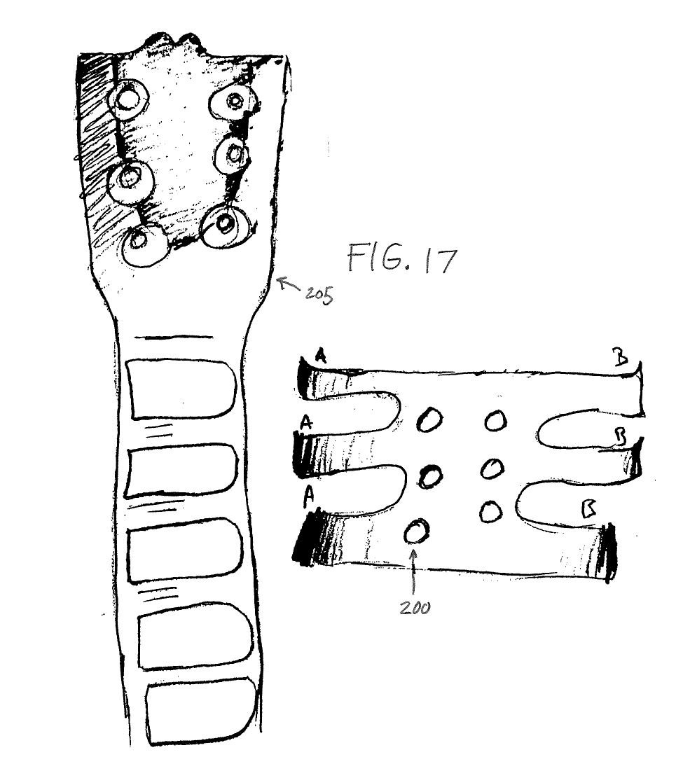

In some embodiments of the invention, a classical guitar with a slotted headstock without tuning posts but with pegs that go perpendicular through the side of the headstock and of which are exposed in the slots of the headstock would also be encompassed by the invention in that the button on the bottom of the tuneroo which is used for fitting over the post on instruments which have posts in this manner, would instead fit between the strings in that the outside of the button would hold the piece in place by inserting it between the taught strings on the front side of the classical guitar headstock. On a classical guitar with this different design would be either attached to the pegs through the manner of an adapter which would enable the tuneroo to attach to this guitar for any similar or same decorative purpose. FIGS. 13 and 14 illustrate cappers of this embodiment, wherein FIG. 13 shows a capper with grooves 100 on the post 90 of a guitar. FIG. 14 shows the capper 120 with strings 130 holding grooves 110 via tension between the strings. And FIG. 15 shows the underside of a capper with material removed in space 140 to allow placement over a guitar peg (not shown). FIG. 16 further illustrates a capper 160 with design surface 150 on a head of a classical guitar before nut 170, and this capper 160 is shown being held in tension between strings 180 and 190.

Also in the idea of attaching the tuneroo pieces between strings, this can be done on the opposite side of the nut (i.e. the sounding side) so as to either mute the strings in a quiet studio where resonant sounds and sympathetic vibrations are unwanted, or as a means of creative expression by the musician using the tuneroo pieces. From there it would follow that in the tradition of many artists who have modified their instruments through the years, tuneroos can be adapted to include sound generating capacity themselves, or to transmit a signal triggered by the vibrations of the strings to a synthesizer, or computer which enables a musician to create a synthesized instrument out of an actual instrument (in practice known as “prepared” instruments). Thus the pieces can even be adapted to fit between the keys of a piano.

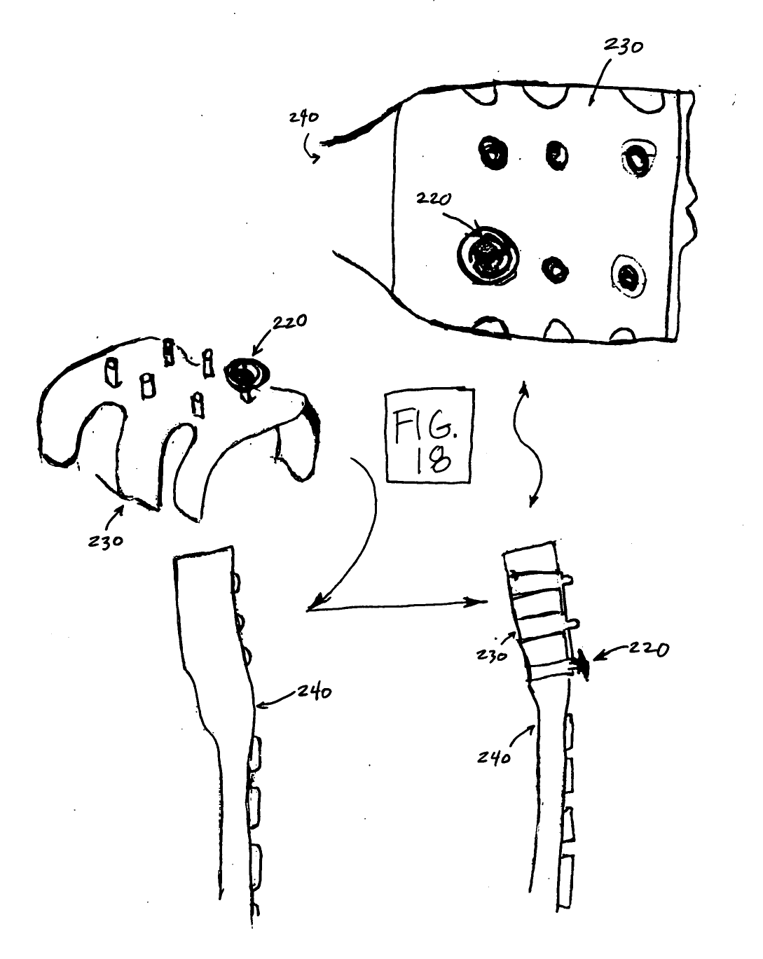

In embodiments applicable to instrument like devices, an adaptor is included within the scope of the invention, since most of the controllers for computer gaming systems do not have a physical three-dimensional post that actually protrudes from the instrument-like head. However, at least in one instance, the controller encasement for the Nintendo Wii® (the Wii controller fits into the guitar shaped adapter for the guitar games) does have posts for the purpose assumingly of a more realistic looking simulation, and thus does not necessarily require an adaptor. Although strings themselves do not wrap around these pegs, nor do they have a hole in them to tie through, certain embodiments of the invention have an adapted attachment portion of the tuneroo which enables them to adorn the type of guitar controller lacking a three-dimensional post in the same manner in which that it would decorate a real guitar. Accordingly, for the guitar shaped controllers which simulate real guitars, which do not have actual three dimensional protrusions which could serve as a means to attach the tuneroos, it follows that tuneroos would in order to remain adaptive in the competitive market for promotional materials for popular memorabilia items that the present inventions include embodiments of adapters which are designed for the purpose of making a tuneroo fit onto such instrument-like guitar controllers. Means of which adapters could attach to different guitar simulations could vary from adhesive sticking that may be temporary or even permanent. Other attachment means within the scope of embodiments of the invention include a sleeve that would be in the shape of the exact inversion of the design of the simulations headstock, which would have on it posts which fit in the same configuration that are on a real guitar. Other attachment means could be straps, or ties to enable the posts to remain in place so that people could place the tuneroos for the purpose of personalizing, and decorating their simulations of guitars. FIG. 17 indicates one adaptor 200 having three-dimensional posts of one embodiment of the invention for use on a guitar controller 205 with two dimensional posts that simulate the look of a real guitar. In this non-limiting illustration the adaptor 200 could be strapped around to attach parts A to parts B, as shown schematically in FIG. 18. FIG. 18, shows another adaptor 230, with a capper 220 attached, being placed on a controller 240, from both a side view and top view perspective.

In still other embodiments of the invention, cappers or tuneroos can have extensions such as arms or hair such as found on products which are made to be placed on the end of a pencil or other writing utensil. Tuneroos can also be adapted with light emitting diodes (LEDs) or other types of lighting means such as may be known to those skilled in the art. Tuneroos may also be adapted to contain items such as pick-holders.

In preferred embodiments of the invention, the decorative capper piece is intended for placement on the headstock of a guitar or other instrument fitted over the tuning peg, to fit snuggly as a rubber nipple, or thimble, with a slit to allow for fitting over where any string extends toward the nut.

In yet other embodiments of the invention, are decorative pieces that will not permanently attach to an instrument, but will allow the player to customize and decorate to their own liking without lowering the value of the instrument. Similar to the decorative pieces as described above, these alternative tuneroos would be made to fit over the end pins on the bridge of the guitar, or end pins with decorative pieces extended, that would replace the end pin on an acoustic guitar temporarily, or permanently. Also under this embodiment would be any ornamentation to be hung from tone/volume knobs on an electric guitar or bass, or to be hung from the sound hole on an acoustic guitar. Decorative pieces similar to these in design, but rather than fitted over the tuning pegs would be fitted over the tuning keys rather which would serve the dual purpose of protecting the tuning keys from becoming dirty. One other related design would be for products that hang decoratively from the strings on the head side of the nut using the force of gravity while the instrument is held in a playing position, (an example of this design would be a rubber monkey “holding” the string with a tail or hand and hanging down from the guitar). A final variation of these products would be anything similar to that described above that would be used to decorate other instruments of any family. By hanging or attaching anything decorative to any place on any instrument that will not disrupt the functions of said instrument but will also not permanently attach but will decorate the instrument are included. For example, something hanging off of the strings behind the nut on a violin or viola, or hooked around the inside of an “f” hole, or a decorative magnet with the magnet strip covered in felt so as not to damage the instrument for any instrument made of metal of any kind or products made to hang around the valve casings or any other part of a trombone trumpet or tuba which would not disrupt the function or playing of the instrument.

In still yet other embodiments of the invention, tuneroo products are encompassed that resemble any of the functions of the products described above decorative or other wise made of any material not only limited to plastic or rubber, but also of wood, bone, stone, metal, clay or any other material.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An instrument attachment capper adapted to connect to an instrument or instrument-like device, said instrument attachment capper comprising: a body defining a pair of spaced apart faces, one of said faces adapted to be secured to the instrument or instrument-like device in face-to-face relation, and another of the faces adapted for protective, educational, or decorative purposes, and wherein said body includes a cup with an optional slit.

2. The instrument capper of claim 1, wherein the cup has at least one slit to allow a string to pass through the body.

3. The instrument capper of claim 2, wherein the cup has a second slit.

4. The instrument capper of claim 1, wherein the cup is characterized as containing a face that can be snapped onto an instrument peg or post.

5. The instrument capper of claim 1, wherein the cup has external grooves further adapted to allow two different instrument strings to secure the body.

6. The instrument capper of claim 1, further comprising an instrument or an instrument-like device attached to the instrument capper.

7. The instrument capper of claim 6, wherein the instrument or instrument-like device is guitar shaped and comprises a peg or a post having a face.

8. The instrument capper of claim 6, further comprising an instrument-like device intermediate adaptor having a three dimensional peg or post having a face.

9. The instrument capper of claim 1, wherein the body is composed of a plastic component or a rubber component or a mixture thereof.

10. The instrument capper of claim 1, wherein the body further comprises a LED or a pick-holder.

11. An instrument attachment capper adapted to connect to an instrument or instrument-like device, said instrument attachment capper comprising: a body defining a pair of spaced apart faces, one of said faces adapted to be secured to the instrument or instrument-like device in face-to-face relation, and another of the faces adapted for protective, educational, or decorative purposes, and wherein said body is characterized as an acoustic guitar bridge pin.

12. An instrument attachment capper adapted to connect to an instrument or instrument-like device, said instrument attachment capper comprising: a body defining a pair of spaced apart faces, one of said faces adapted to be secured to the instrument or instrument-like device with a hook or hangar, and another of the faces adapted for protective, educational, or decorative purpose.

13. The instrument capper of claim 12, wherein the hook or hangar is adapted to attach to a knob on the instrument or instrument-like device.

14. The instrument capper of claim 12, wherein the hook or hangar is adapted to attach to a sound hole in the instrument or instrument-like device.

15. The instrument capper of claim 12, wherein the hook or hangar is adapted to attach to a string of the instrument or instrument-like device.
